(19) United States
(12) Patent Application Publication
(10) Pub. No.: US 2004/0212353 A1
(43) Pub. Date: Oct. 28, 2004

(54) Use of a closing impedance to minimize the adverse impact of out-of-phase generator synchronization

(75) Inventor: Robert J. Nelson, Orlando, FL (US)

Correspondence Address: Siemens Corporation, Intellectual Property Department, 186 Wood Avenue South, Iselin, NJ, 08830, US

(73) Assignee: Siemens Westinghouse Power Corporation

(21) Appl. No.: 10/423,529

(22) Filed: Apr. 25, 2003

(51) Int. Cl. H02P 9/00

(52) U.S. Cl. 322/45

(57) ABSTRACT

A power system (8) comprising an electrical generator (12) connected to a transmission/distribution system (15) via a circuit breaker (14). The circuit breaker (14) further comprises a shorting element (20) and an impedance (22) in parallel thereto. The impedance (22) is closed immediately prior to closure of the shorting element (20), thereby inserting the impedance (22) into the circuit to reduce the switching transients caused by an out-of-phase condition between the current generated by the electrical generator (12) and the current carried by the transmission/distribution system (15).

### FIELD OF THE INVENTION

The present invention relates generally to synchronizing an electric generator to an electrical power transmission system, and more particularly, to the use of an impedance in the closing circuit for limiting generator torques that may be produced during out-of-phase synchronization.

### BACKGROUND OF THE INVENTION

An electric generator produces electricity, typically three-phase electricity, in response to a turning torque provided by a combustion or steam-driven turbine. The generator is a dynamoelectric machine employing the principles of generator action to produce the electrical output. The generator is a mechanically massive structure and electrically complex, with typical output power ratings up to 1,500 MVA at voltages up to 26 kilovolts (kV).

Conventionally, the electric generator comprises a rotor, carrying axial field or rotor windings for producing a magnetic flux field in response to an input current. The rotor rotates within a stationary armature or stator winding of the generator. The input current is direct current supplied from a separate exciter to generate the magnetic field of the rotor. One end of the rotor shaft is drivingly coupled to a steam or gas-driven turbine for providing rotational energy to turn the rotor.

The stator comprises a core including a plurality of thin, high-permeability circumferential slotted laminations placed in a side-by-side orientation and insulated from each other to reduce eddy current losses. Stator coils are wound within inwardly directed slots of the stator core. Alternating current is induced in the stator windings by the action of the rotating magnetic field produced by the current-carrying rotor windings. The alternating current generated within the stator windings flows to terminals mounted on the generator frame for connection to an external electrical load. Three-phase alternating current is supplied from a generator having three independent stator windings spaced at 120° around the stator shell. Single-phase alternating current is supplied from a single stator winding.

These electrical power generators serve as the primary power producers in electrical power systems. Such systems include transmission lines for carrying electrical power from the generating site to the consuming site via a plurality of voltage step up and step down transformers and intervening transmission and distribution lines. The generator output current is directed to a transmission-switching yard where the current is switched onto one or more transmission lines that carry the power to a region of the power system (also referred to as the power grid). The transmission lines feed a step-up transformer for increasing the current magnitude for transmission over the transmission line segment of the power system. The transmission segment gives way to the distribution segment, including distribution lines and attendant step-down transformers for providing the power to the consumer.

The power transmission and distribution networks stretch across the region served by an electric utility, and may include a number of satellite power generators that are periodically connected to and disconnected from the power system to augment the primary generator power, as the power demands increase or decrease in various parts of the power network. In view of the substantial power carried by the power system and generated by the electrical generators, certain parameters of the generator output power and the transmission line power must be within predefined tolerable limits of each other before the electrical generator can be connected to the power system. In particular, the magnitude, phase and frequency of the generated power must be within predefined margins of the transmission line power magnitude, phase and frequency. If these conditions are not satisfied, upon connection of the generator to the power system, the generator rotor can be forcibly jerked into synchronization, inducing substantial torques on the generator components, in particular, on the turbine shaft.

As described above, the generator is drivingly coupled to a turbine for supplying the rotational torque necessary to produce the generator action. To connect an operating generator to the power system, the turbine is controlled to bring the generator up to its operational speed, at which time a circuit breaker is closed to connect the generator output terminals to the power lines of the power system. Typically, the circuit breaker is located in the transmission-switching yard, on the high side of the step-up transformer. If the phase and frequency of the generator and the power line to which it is connected are not closely matched at the time the breaker is closed, very large energy transfers occur between the power system and the generator. The resulting substantial electric currents and torque forces produced thereby can cause costly damage to the generator stator windings and the power system components. The accompanying transient torque on the rotor shaft can reach values up to 20 times design torque and cause a shaft failure. Also, in a situation where the generator is brought on-line slightly out-of-synchronization (for example, 20° out of phase synchronization), serious shaft damage can occur if the shaft had sustained prior damage, for example, due to previous out-of-phase synchronization events.

Certain standards-setting organizations recommend no more than a +/−10 degree difference between the phase values at synchronization. Certain generator suppliers recommend +/−5 degrees limit. However, it is generally conceded that little damage should result from synchronizations at less than a 30-degree phase difference for a rotor shaft with no existing damage. Beyond 30 degrees, damage can generally be expected. As a practical matter, the phase angle difference is usually less than 5 degrees if the synchronizing equipment is correctly installed. However, when incorrectly installed, the synchronizing equipment can cause a synchronization attempt to be off by 120 degrees or 180 degrees. These incorrect installations are typically the result of reversed voltage transformer connections (i.e., the transformers that sense the generator and grid voltages). Even in a situation where no observable damage occurs, an attempted connection of the generator into an operating power system without proper phase synchronization can create an unsafe excess current condition, causing protective relays of the power system to open. These protective relays sense the excess currents and open to protect the grid from over-current damage.

It is therefore necessary to synchronize the generator output current and the transmission line current before the generator is connected to the line. Further, it is advantageous for the synchronization process to be conducted rapidly and accurately, as during times of fluctuating power demand it may be necessary to frequently connect and disconnect generators from the power system grid.

To effect synchronization, the generator speed must be within a predefined range that provides for substantial matching of the generator electrical output frequency and the power system electrical frequency. Also, the generator voltage magnitude should be within a predefined range of the grid voltage. The phase difference between the generator voltage waveform and the power system voltage waveform should be approaching zero so that breaker closure occurs substantially at the zero or coincident phase relationship between these two waveforms. If these conditions are met, generator damage and disturbances on the electrical power system can be avoided.

Gas turbine-driven generators are utilized by electric utilities to serve peak power needs. Thus it is advantageous for the generator to provide fast start-up and synchronization so that a power outage can be avoided. The ability to quickly synchronize the generator to the grid thus improves the power plant availability for power generation. As electric utilities increase their reliance on gas turbine-driven generators for satisfying peak power demands and backup requirements, the need for rapid synchronization capabilities is especially acute. The utility of such gas-turbine generating units is enhanced when they can be placed on line in a shorter time and with higher reliability than is possible using the prior art synchronization methods.

One prior art synchronization scheme employs a synchroscope that provides a visual indication of the degree of phase difference between the generator and the grid voltage, and the slip or rate of change of that phase difference. The operator manually corrects the phase difference by raising or lowering, as required, the speed of the generator, by raising or lowering the speed of the driving turbine. Concurrently, the operator adjusts the generator voltage until the generator output voltage and the grid voltage are substantially equal. When the generator reaches frequency synchronization in response to the operator's manual control, the operator initiates a circuit breaker closure signal and in response thereto the breaker closes to connect the generator to the power grid. In practice, the operator generally anticipates the breaker closing time to provide for actual closure as the two voltage waveforms approach or are at the point of phase coincidence.

Other prior art synchronization schemes replace the manual operation with an automated process that monitors the voltage magnitude and phase angles of the generator and power grid, providing feedback control over the former until the generator operating parameters allow synchronization with the power grid. Breaker closure is then automatically initiated and the generator is at that point synchronized to the grid. Such automatic power plant synchronization schemes are today typically controlled by digital computers or digital processors.

The most simplistic synchronization schemes employs light bulbs (one for each generator output terminal) connected between the generator output and the power system. When the generator and the power system are synchronized, there is no voltage across the bulb and it is therefore not illuminated. It is at this point that the generator circuit breaker should be closed. When the bulb is illuminated the generator is not synchronized to the grid. The bulb will flicker as the phase relationship between the generator and the grid changes.

It is known that extra-high voltage circuit breakers, for example, those operating in transmission lines of 550 kV or more should preferably be closed through a closing resistor to limit overvoltage switching transients caused by trapped charges on the transmission line. Such overvoltage values can exceed the insulation rating of the line and cause destructive flashovers. In one embodiment, the closing resistor comprises a stack of resistive disks connected in parallel with the circuit breaker interrupter contacts. The resistor contacts close before the interrupter contacts, thereby pre-inserting the resistor into the circuit. The main interrupter contacts then close, short circuiting the closing resistor. Once the interrupter contacts are closed, the resistor contacts can be opened to remove the resistor from the circuit. Passing the closing current through the closing resistor reduces the surge overvoltages that can be otherwise be created on the power line. In some cases these overvoltages can exceed the lightning insulation rating of the power line cable.

To the extent of the knowledge of the present inventors, closing resistors have never been used with the main generator breakers at a power generating station. Closing resistors have been applied when the systems being interconnected are electrically “weak” (measured in terms of short-circuit strength). Generators have a high short-circuit strength and are thus considered “strong”, militating against use of closing resistors for generator applications.

Typically, the closing resistors are located physically adjacent to and coextensive with the interrupter contacts assembly. Typical resistance values are in the range of 500 ohms and closure times (i.e., the time during which the resistor is inserted into the circuit prior to closing the main interrupter contacts) is about 10 milliseconds. In certain applications a capacitor is disposed parallel to the closing resistor to limit the transient recovery voltage.

### BRIEF SUMMARY OF THE INVENTION

An electrical generator generates current that is supplied to a power system carrying electrical current. The generator comprises a stator having one or more stator windings for producing the current at one or more stator output terminals, and a rotor shaft disposed within the one or more stator windings and drivingly coupled to a prime mover for supplying rotational energy to the shaft. The rotor shaft also carries a plurality of rotor windings that are responsive to an externally-supplied exciter current for inducing a magnetic field around the plurality of rotor windings. Rotation of the rotor windings generates the electrical current in the one or more stator windings. A shorting element is disposed between the one or more output terminals and the power system. When closed, the shorting element connects the one or more output terminals to the power system. An impedance in parallel with the shorting element is inserted between the one or more output terminals and the power system prior to closing the shorting element.

### BRIEF DESCRIPTION OF THE DRAWINGS

The foregoing and other features of the invention will be apparent from the following more particular description of the invention, as illustrated in the accompanying drawings, in which like reference characters refer to the same parts throughout the different figures. The drawings are not necessarily to scale, emphasis instead being placed upon illustrating the principles of the invention.

FIG. 1 is a block diagram generally illustrating a power system using a circuit breaker as described herein; and

FIG. 2 is a part schematic and part block diagram of a circuit breaker for use according to the teachings of the present invention.

### DETAILED DESCRIPTION OF THE INVENTION

Before describing in detail the particular power generating system and method in accordance with the present invention, it should be observed that the present invention resides primarily in a novel and non-obvious combination of hardware elements and method steps. Accordingly, these elements and steps have been represented by conventional elements and steps in the drawings, showing only those specific details that are pertinent to the present invention, so as not to obscure the disclosure with details that will be readily apparent to those skilled in the art having the benefit of the description herein.

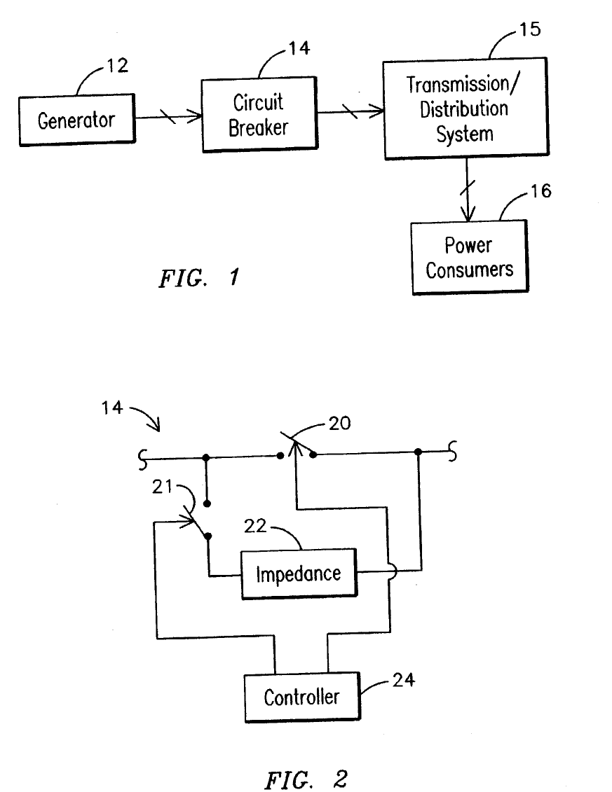

FIG. 1 illustrates, in block diagram form, a power system 8, comprising a generator 12 supplying electric power via a circuit breaker 14 to a transmission\distribution system 15, that in turn provides power to power consumers 16. As described above, the circuit breaker 14 is closed at the appropriate time to synchronize the phase, frequency and magnitude of the current/voltage output of the generator 12 to the phase, frequency and magnitude of the current/voltage of the transmission/distribution system 15, thereby avoiding damage to the transmission/distribution system 15 and the generator 12.

FIG. 2 illustrates further details of the circuit breaker 14 according to the teachings of the present invention, comprising a switchable shorting element 20, and a series combination of a switch 21 and an impedance 22, oriented in electrically parallel relationship with the switchable shorting element 20. The assembly of components illustrated in FIG. 2 is repeated for each phase winding of the generator. However, the controller 24 can be configured to control the shorting element 20 and the switch 21 for all phase windings, obviating the need for a controller for each phase. A controller 24 controls the opening and closing operations of the switch 21 and the switchable shorting element 20, thereby controlling insertion and removal of the impedance 22 across the switchable shorting element 20. Although the switchable shorting element 20 and the switch 21 are shown as single-pull single-throw mechanical switches in FIG. 2, those skilled in the art recognize that other mechanical and electrical devices capable of controlled opening and closing of a circuit can be used. For example, a semiconductor switching device can be used as the switchable shorting element 20 and the switch 21 in certain applications. Given its high current operating environment and the necessity for repeated switch operations during periods of high current, the circuit breaker 14 is typically a complex device including various protective and functional elements not shown in FIG. 2.

In operation, as the generator 12 is controlled to approach synchronization with the transmission/distribution system 15, the controller 24 (under automatic or manual control) closes the switch 21 to insert the impedance 22 across the switchable shorting element 20. After a predetermined time interval (in one embodiment about 0.01 seconds), the switchable shorting element 20 is closed, shorting the impedance 22. Thereafter the switch 21 is opened to prepare the circuit breaker 14 for the next closing cycle.

In one embodiment, the impedance 22 comprises a resistor (referred to in the art as a closing resistor) having a current-carrying capacity sufficient to carry the current passing through the circuit breaker 14, and having a resistance value suitable for reducing the effects of transient overvoltages that can be produced when the switchable shorting element 21 connects an out-of-phase generator 12 with the transmission/distribution system 15.

If the generator 12 is 120° out of phase synchronization with the electrical waveform on the transmission/distribution system 15, a substantial torque can be developed in the generator rotor and the shaft of the turbine supplying rotational energy to the generator 12. It has been experimentally determined that this torque peaks at about 0.005 seconds after the generator 12 is synchronized to the transmission/distribution system 15. As discussed above, if this torque is of a sufficiently large, it can cause failure of the turbine shaft, generator shaft, or other generator components. In one embodiment, inserting an impedance 22 having appropriately selected properties into the circuit reduces the peak torque by about 50 percent, thus significantly reducing the likelihood of damage to the generator and turbine components. The impedance 22 also reduces the over-currents produced in the generator 12 due to the out-of-phase synchronization.

It is known that there are two major torque components created by an out-of-synchronization event. A unidirectional torque that “drags” the generator into synchronization with the power system and another torque that causes oscillating forces within the generator components. The oscillatory torque is caused by a “trapped flux” that is determined by the rotor position and the strength of the rotor magnetic field at the instant when the circuit breaker is closed. Use of a impedance 22 according to the teachings of the present invention allows the trapped flux to attenuate quickly, thus reducing the oscillatory torque. The impedance 22 also reduces the magnitude of the unidirectional torque. The present inventor has recognized that the kinetic energy generated by out-of-phase generator synchronization had been dissipated in prior art systems through the exertion of mechanical work within the generator. He has further recognized that this kinetic energy is better dissipated in the system of the present invention through the creation of heat in an impedance element 22. The present invention provides an apparatus and method to effectively dissipate this potentially destructive kinetic energy, lowering the risk of mechanical damage to the generator.

Assuming a standard or typical generator reactance of 15 percent to 30 percent of the generator's base impedance, which is defined as the square of the generator terminal voltage divided by the generator volt-ampere rating, and a closing resistance value (i.e., wherein the impedance 22 comprises a closing resistor as described above) of less than about one percent of the generator's base impedance, it has been determined that the use of a closing resistor increases the effective system resistance in the range of about 60 percent during the time that the closing resistor is inserted in the circuit. The resulting torque for an out-of-phase synchronization occurrence under these conditions is considerably less than the conventional maximum design torque that the generator and turbine shafts are capable of withstanding, even if a 120° out-of-phase synchronization (which generate the highest torques) occurs. For typical characteristic impedances of the generator 12 and transmission/distribution systems 15, the impedance 22 should have a resistance of between about 50 to 500 ohms per phase.

In lieu of a simple resistor, the impedance 22 can comprise a reactive element such as an inductor. It is known that most resistors have a fairly low power factor, that is, the resistor exhibits some inductive reactance. That is, the impedance of a resistor is given by Z=R+jX, where Z is the total impedance, R is the resistance or the resistive component, and X is the inherent reactive component of the resistor. The power factor is thus defined as R/(sqrt(R²+X²). A high power-factor resistor approaches an ideal resistor (i.e., R>>X), but such resistors are typically expensive and in certain applications of the present invention the additional expense may not be warranted. Additionally, in certain applications it is not necessary to incur the extra expense of a high power-factor resistor since the additional inductive reactance that is associated with most resistors can be beneficial. In another embodiment, it may be beneficial to include a parallel inductance with the resistor.

According to the prior art, to reduce the effects an out-of-phase synchronization event, the generator and/or turbine shaft is extensively reinforced to withstand the out-of-phase synchronization torques. According to the teachings of the present invention, since the use of a closing resistor reduces these out-of-phase synchronization torques, it may not be necessary to reinforce the shafts, as the closing resistor absorbs the voltage transient and thereby reduces the shaft torque as described above. Also, according to the prior art, the generator includes certain components (e, g., protective relays) to trip the generator off-line if the out-of-phase synchronization condition is not quickly remedied (i.e., the generator fails to synchronize with the power system in a predetermined time interval). With the effects of an out-of-phase synchronization reduced according to the teachings of the present invention, the number of generator trips due to out-of-phase synchronization is reduced. These out-of-phase synchronization events can also require costly and time consuming inspection of generator and turbine components to determine whether any damage occurred. Such inspections are avoided by using the closing impedance according to the teachings of the present invention.

While the invention has been described with reference to preferred embodiments, it will be understood by those skilled in the art that various changes may be made and equivalent elements may be substituted for elements thereof without departing from the scope of the present invention. The scope of the present invention further includes any combination of the elements from the various embodiments set forth herein. In addition, modifications may be made to adapt the teachings of the present invention to a particular situation without departing from its scope. Therefore, it is intended that the invention not be limited to the particular embodiment disclosed as the best mode contemplated for carrying out this invention, but that the invention will include all embodiments falling within the scope of the appended claims.

What is claimed is:

1. An electrical generator drivingly coupled to a prime mover for supplying electric current to a power system, comprising:
a stator comprising one or more stator windings and one or more stator output terminals;
a rotor shaft disposed within the one or more stator windings and drivingly coupled to the prime mover for supplying rotational energy to the rotor shaft;
a plurality of rotor windings disposed on the rotor shaft and responsive to an externally-supplied exciter current for creating a magnetic field proximate the plurality of rotor windings, wherein rotation of the rotor windings induces electrical current in the one or more stator windings;
wherein the electric current is supplied to the one or more stator output terminals;
a shorting element disposed between the one or more stator output terminals and the power system, wherein the shorting element is operative in an opened or closed state for connecting the one or more stator output terminals to the power system when in the closed state; and
an impedance in parallel with the shorting element selectively insertable between the one or more stator output terminals and the power system prior to closing the shorting element.

2. The electrical generator of claim 1 wherein the impedance comprises one or more of a resistor and an inductor.

3. The electrical generator of claim 1 wherein the impedance comprises a resistor having a resistance of between about 50 and 500 ohms.

4. The electrical generator of claim 1 wherein the impedance comprises a resistive component and a reactive component, and wherein the resistive component is between about 50 and 500 ohms.

5. The electrical generator of claim 1 wherein the shorting element is selected from between a circuit breaker and a semiconductor switching device.

6. The electrical generator of claim 1 further comprising a controller for selectively inserting the impedance between the one or more stator output terminals and the power system for a predetermined time prior to closure of the shorting element.

7. The electrical generator of claim 6 wherein the predetermined time is about 0.01 seconds.

8. The electrical generator of claim 1 further comprising a controller and a switch in serial relation with the impedance, wherein the controller closes the switch to insert the impedance between the one or more stator output terminals and the power system.

9. The electrical generator of claim 8 wherein the controller opens the switch after the shorting element is closed.

10. The electrical generator of claim 1 further comprising a controller, wherein the power system carries electrical current, and wherein the controller closes the shorting element when a phase angle of the electric current supplied to the one or more stator output terminals has a predetermined relation with a phase angle of the electrical current carried over the power system.

11. The electrical generator of claim 10 wherein the controller inserts the impedance between the one or more output terminals and the power system for limiting the effects of a difference between the phase angle of the electric current supplied to the one or more stator output terminals and the phase angle of the electrical current carried over the power system.

12. A power system for generating and distributing electric current to users, the power system comprising:
an electrical generator for producing current at one or more output terminals thereof;
a transmission system connected to the one or more output terminals for receiving the current and for distributing the current to the users;
a shorting element disposed between the one or more output terminals and the transmission system for connecting the one or more output terminals to the transmission system when disposed in a closed state; and
an impedance disposed in electrical parallel relationship with the shorting element for selective insertion between the one or more output terminals and the transmission system prior to closing the shorting element.

13. The power system of claim 12 wherein the impedance comprises one or more of a resistor and an inductor.

14. The power system of claim 12 wherein the impedance comprises a resistor having a resistance value between about 50 and 500 ohms.

15. The power system of claim 12 wherein the impedance comprises a resistive component and a reactive component, wherein the value of the resistive component is between about 50 and 500 ohms.

16. The power system of claim 12 wherein the shorting element is selected from between a circuit breaker and a semiconductor switching device.

17. The power system of claim 12, further comprising a controller, and wherein the controller inserts the impedance between the one or more output terminals and the power system for a predetermined time prior to closure of the shorting element.

18. The power system of claim 12, further comprising a controller and a switch in serial relationship with the impedance, and wherein the controller closes the switch to insert the impedance between the one or more output terminals and the transmission system.

19. The power system of claim 18 wherein the controller opens the switch after the shorting element is closed.

20. The power system of claim 12, further comprising a controller, wherein the controller closes the shorting element in response to a predetermined relation between a phase angle of the current produced at the one or more output terminals and a phase angle of the current distributed by the transmission system, and wherein the controller inserts the impedance between the one or more output terminals and the transmission system for limiting the effects of a difference between the phase angle of the current produced at the one or more output terminals and the phase angle of the current distributed by the transmission system.

21. A method for supplying additional electric current to a power system carrying electric current, comprising:
(a) generating the additional electric current at a generator, wherein there exists a phase angle difference between the electric current carried by the power system and the additional electric current;
(b) connecting the generator to the power system through an impedance; and
(c) shorting the impedance after a predetermined time.

22. The method of claim 21 wherein the step (b) further comprises connecting the generator to the power system through the impedance in response to a predetermined phase angle difference.

23. The method of claim 21 wherein a switching element in serial relation to the impedance is operative in an opened and a closed state, and wherein the step (b) further comprises closing the switching element.

24. The method of claim 23 further comprising a step (d) opening the switching element after the step (c).

25. The method of claim 24 wherein the impedance is selected from among a resistor and an inductor.

26. The method of claim 21 wherein the impedance comprises a resistive component of between about 50 and 500 ohms.

27. A method for protecting an electrical generator during out-of-phase synchronization to a power system comprising shunting at least a portion of the kinetic energy generated during the out-of-phase synchronization event to an impedance for conversion to heat.
